(19) United States
(12) Patent Application Publication
(10) Pub. No.: US 2017/0012908 A1
(43) Pub. Date: Jan. 12, 2017

(54) COMPUTING SYSTEM WITH MESSAGING MECHANISM AND METHOD OF OPERATION THEREOF

(71) Applicant: Telenav, Inc., Santa Clara, CA (US)

(72) Inventor: Ming Guo, San Jose, CA (US)

(21) Appl. No.: 15/202,320

(22) Filed: Jul. 5, 2016

Related U.S. Application Data
(60) Provisional application No. 62/190,081, filed on Jul. 8, 2015.

(51) Int. Cl. H04L 12/58; H04W 4/14

(52) U.S. Cl. CPC H04L 51/063; H04L 51/20; H04L 51/32; H04L 51/10; H04W 4/14

(57) ABSTRACT

A method of operation of a navigation system includes: receiving an application message for communicating with a device of a sender with a messaging application installed; and generating a non-application message based on converting the application message dynamically and in real time with a control unit for communicating with the device of a recipient without the messaging application installed.

### CROSS-REFERENCE TO RELATED APPLICATION(S)

This application claims the benefit of U.S. Provisional Patent Application Ser. No. 62/190,081 filed Jul. 8, 2015, and the subject matter thereof is incorporated herein by reference thereto.

### TECHNICAL FIELD

The present invention relates generally to a computing system, and more particularly to a system with messaging mechanism.

### BACKGROUND ART

Modern portable consumer and industrial electronics, especially client devices such as navigation systems, cellular phones, portable digital assistants, and combination devices, are providing increasing levels of functionality to support modern life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. One existing approach is to use location information to provide navigation services such as a global positioning system (GPS) for a car or on a mobile device such as a cell phone, portable navigation device (PND) or a personal digital assistant (PDA).

Location based services allow users to create, transfer, store, and/or consume information in order for users to create, transfer, store, and consume in the “real world.” One such use of location based services is to efficiently transfer or route users to the desired destination or service.

Computing systems and location based services enabled systems have been incorporated in automobiles, notebooks, handheld devices, and other portable products. Today, these systems aid users by incorporating available, real-time relevant information, such as maps, directions, local businesses, or other points of interest (POI). The real-time information provides invaluable relevant information.

However, a computing system improving messaging mechanism to communicate over different platforms has become a paramount concern for the consumer. The inability decreases the benefit of using the tool.

Thus, a need still remains for a computing system with messaging mechanism to communicate between different platforms. In view of the increasing mobility of the workforce and social interaction, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### DISCLOSURE OF THE INVENTION

The present invention provides a method of operation of a navigation system including: receiving an application message for communicating with a device of a sender with a messaging application installed; and generating a non-application message based on converting the application message dynamically and in real time with a control unit for communicating with the device of a recipient without the messaging application installed.

The present invention provides a method of operation of a navigation system including: receiving a non-application message for communicating with a device of a sender without a messaging application installed; and generating an application message based on converting the non-application message dynamically and in real time with a control unit for communicating with the device of a recipient with the messaging application installed.

The present invention provides a navigation system, including: a communication unit for receiving an application message for communicating with a device of a sender with a messaging application installed; and a control unit, coupled to the communication unit, for generating a non-application message based on converting the application message dynamically and in real time with a control unit for communicating with the device of a recipient without the messaging application installed.

The present invention provides a navigation system, including: a communication unit for receiving a non-application message for communicating with a device of a sender without a messaging application installed; and a control unit, coupled to the communication unit, for generating an application message based on converting the non-application message dynamically and in real time with a control unit for communicating with the device of a recipient with the messaging application installed.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a computing system with messaging mechanism in an embodiment of the present invention.

FIG. 2 is an example of an architecture of the computing system.

FIG. 3 is an exemplary block diagram of the computing system.

FIG. 4 is a control flow of the computing system.

FIG. 5 is a flow chart of a method of operation of the computing system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the computing system 100 are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element including a speed component and a heading component.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a module is written in the apparatus claims section below, the modules are deemed to include hardware circuitry for the purposes and the scope of apparatus claims.

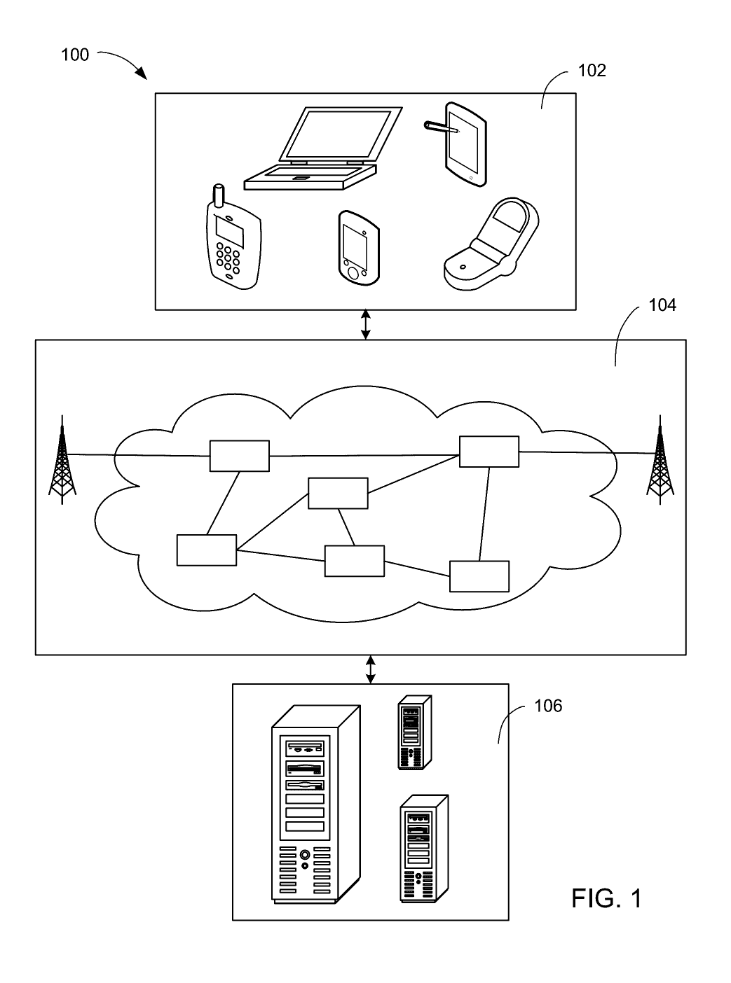

Referring now to FIG. 1, therein is shown a computing system 100 with messaging mechanism in an embodiment of the present invention. The computing system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic computing system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the computing system 100 is described with the first device 102 as a mobile computing device, although it is understood that the first device 102 can be different types of computing devices. For example, the first device 102 can also be a non-mobile computing device, such as a server, a server farm, or a desktop computer. In another example, the first device 102 can be a particularized machine, such as a mainframe, a server, a cluster server, rack mounted server, or a blade server, or as more specific examples, an IBM System z10™ Business Class mainframe or a HP ProLiant ML™ server.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102. Another example, the first device 102 or the second device 106 can be a particularized machine, such as a portable computing device, a thin client, a notebook, a netbook, a smartphone, a tablet, a personal digital assistant, or a cellular phone, and as specific examples, an Apple iPhone™, Android™ smartphone, or Windows™ platform smartphone.

For illustrative purposes, the computing system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

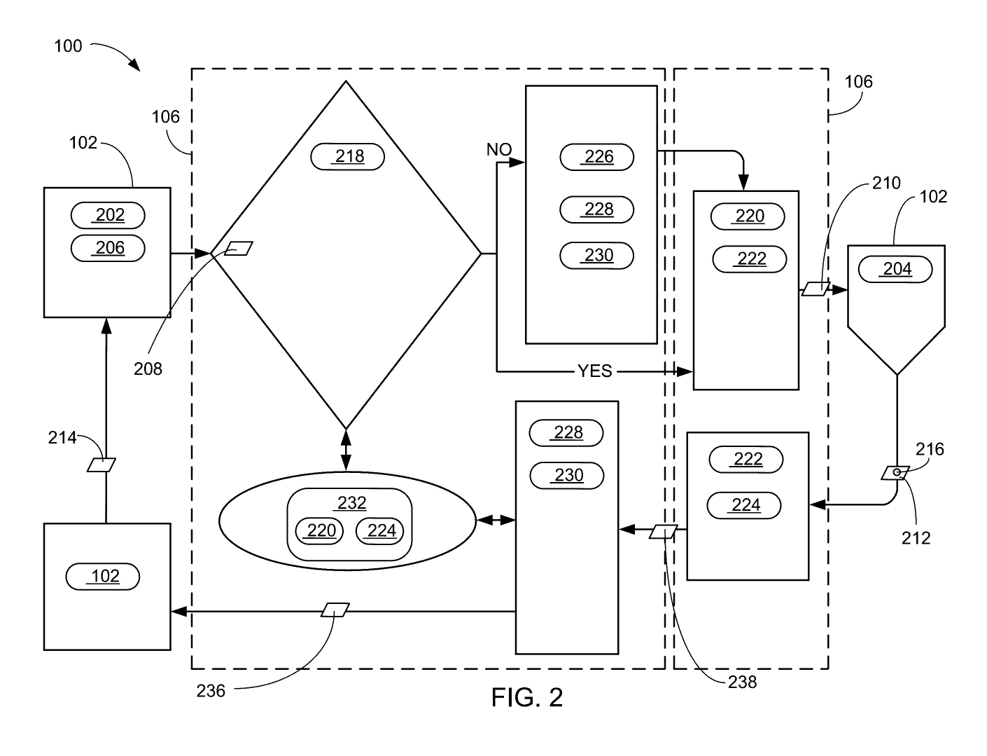

Referring now to FIG. 2, there is shown an example of an architecture of the computing system 100. For clarity and brevity, the discussion of the embodiment of the present invention will focus on the first device 102 delivering the result generated by the computing system 100. However, the second device 106 of FIG. 1 and the first device 102 can be discussed interchangeably.

The computing system 100 can host the interaction between a sender 202 and a recipient 204. The sender 202 is defined as a user initiating a communication via the computing system 100 to the recipient 204. The recipient 204 is defined as another user receiving the communication from the sender 202. The sender 202 and the recipient 204 can be different.

For example, the sender 202 can have a messaging application 206 installed on the first device 102 of the sender 202 or a sender's device. For further example, the first device 102 of the recipient 204 or a recipient's device may not have the messaging application 206 installed. For a different example, the recipient 204 can have a messaging application 206 installed on the first device 102 of the recipient 204. For further example, the first device 102 of the sender 202 may not have the messaging application 206 installed.

The messaging application 206 is defined as software or mobile application for an instant messaging. The instant messaging can represent a type of online chat which offers real-time text transmission over the Internet. For example, the messaging application 206 can include LINE™, WhatsApp™, WeChat™, or Facebook Messenger™

The messaging application 206 can be different from a text messaging service component of the first device 102 representing a mobile device or client. For example, the text messaging service component can represent Short Message Service (SMS), Multimedia Message Service (MMS), or a combination thereof. Unlike the instant messaging, the text messaging service component can use well-defined formats or communication protocol for exchanging messages. The communication protocol can specify rules governing the transmission between devices. For example, the communication protocol can include data format, address format, address mapping, routing, detection of transmission error, acknowledgement, loss of information, direction of information flow, sequence flow, flow control, or a combination thereof.

An application message 236 is defined as a message in a format of instant messaging. For example, the application message 236 can include a sender application message 208, a reply application message 214, or a combination thereof for communicating to or from the messaging application 206. A non-application message 238 is defined as a message formatted for using the text message service component. For example, the non-application message 238 can include a sender text message 210, a reply text message 212, or a combination thereof.

For a specific example, the sender 202 can send the sender application message 208. The sender application message 208 is defined as a message sent in a format of the messaging application 206. For example, the sender 202 can send the sender application message 208 representing LINE™ message.

The computing system 100 can convert the sender application message 208 into the sender text message 210 if the first device 102 of the recipient 204 does not have the messaging application 206 installed. The sender text message 210 is defined as a message sent using the text messaging service component. For example, the sender text message 210 can represent an SMS or MMS message.

Continuing with the example, the recipient 204 can respond to the sender text message 210 with the reply text message 212 because the first device 102 of the recipient 204 may not have the messaging application 206 installed. The reply text message 212 is defined as a message replied using the text messaging service component. For example, the reply text message 212 can represent an SMS or MMS message.

The computing system 100 can convert the reply text message 212 into the reply application message 214 if the first device 102 of the sender 202 has the messaging application 206 installed. The reply application message 214 is defined as a message replied in a format of the messaging application 206. For example, the recipient 204 can reply with the reply application message 214 representing LINE™ message.

A message content 216 is defined as information prepared for conveying to a user. For example, the sender application message 208, the sender text message 210, the reply application message 214, the reply text message 212, or a combination thereof can include the message content 216. More specifically as an example, the sender 202, the recipient 204, or a combination thereof can prepare the message content 216 to be communicated via the computing system 100 to be conveyed to each other. The message content 216 can include text, digital file, audio file, video file, binary data, location information, or a combination thereof.

For further example, the examples above used the sender 202 as the user initiating the communication to another user. As a result, the another user can represent the recipient 204 of the communication initiated by the sender 202. However, the users of the sender 202 and the recipient 204 can be discussed interchangeably. More specifically as an example, the user representing the recipient 204 can become the sender 202 and the user representing the sender 202 can become the recipient 204. For further example, the sender application message 208 and the reply application message 214 can be discussed interchangeably. For another example, the sender text message 210 and the reply text message 212 can be discussed interchangeably.

For example, the sender 202 can use the first device 102 without the messaging application 206 installed. As a result, the sender 202 can send the sender text message 210 to the recipient 204. The recipient 204 can use the first device 102 with the messaging application 206 installed. A communication preference 218 of the recipient 204 can represent receiving the communication using one of the messaging application 206 installed on the first device 102. The communication preference 218 is defined as user preference for a communication type. For example, the communication preference 218 can user preference to communicate via the instant messaging, the text messaging service component, or a combination thereof. More specifically as an example, the communication preference 218 of the recipient 204 can represent communicating with WeChat™. As a result, the computing system 100 can convert the sender text message 210 into the sender application message 208 for WeChat for the recipient 204 to receive.

A sender information 220 is defined as identification information of the sender 202. For example, the sender information 220 can include the name of the sender 202, the device identification information for the first device 102 of the sender 202, username of the messaging application 206 for the sender 202, a communication identification 222 of the sender 202, the communication preference 218, or a combination thereof.

A recipient information 224 is defined as identification information of the recipient 204. For example, the sender information 220 can include the name of the recipient 204, the device identification information for the first device 102 of the recipient 204, username of the messaging application 206 for the recipient 204, the communication identification 222 of the recipient 204, the communication preference 218, or a combination thereof. For example, the sender information 220 and the recipient information 224 can be discussed interchangeably.

The communication identification 222 is defined as a contact information of the user. For example, the communication identification 222 can include a phone number, an email address, a login name/username for the messaging application 206, a device identification of the mobile device, a Uniform Resource Locator (URL), or a combination thereof.

A channel 226 is defined as means of communication. For example, the channel 226 can connect the sender 202 and the recipient 204 via the computing system 100. More specifically as an example, the computing system 100 can utilize a communication application program interface platform including Twilio™, Bandwidth™, Sinch™, Nexmo™, Plivo™, or a combination thereof. The channel 226 can represent an account for the communication application program interface platform. For further example, multiple instances of the channel 226 can be assigned to one instance of the recipient 204.

A channel availability 228 is an accessibility of the channel 226. For example, the channel availability 228 can include “available,” “unavailable,” or a combination thereof. A communication status 230 is defined an idleness of the channel 226. For example, if the channel 226 is available, the communication status 230 can be “idle.” For a different example, if the channel 226 is unavailable, the communication status 230 can be “not idle.”

A mapping table 232 is defined as a data structure that maps the sender information 220 and the recipient information 224. For example, the computing system 100 can map the sender information 220 to the recipient information 224 for establishing the communication between the sender 202 and the recipient 204. For further example, the mapping table 232 can include the communication preference 218 for the sender 202, the recipient 204, or a combination thereof. The mapping table 232 can include a timestamp 234 to track a least recently used (LRU) instance of the channel 226. The timestamp 234 can represent a time of day, week, month, year, season, or a combination thereof.

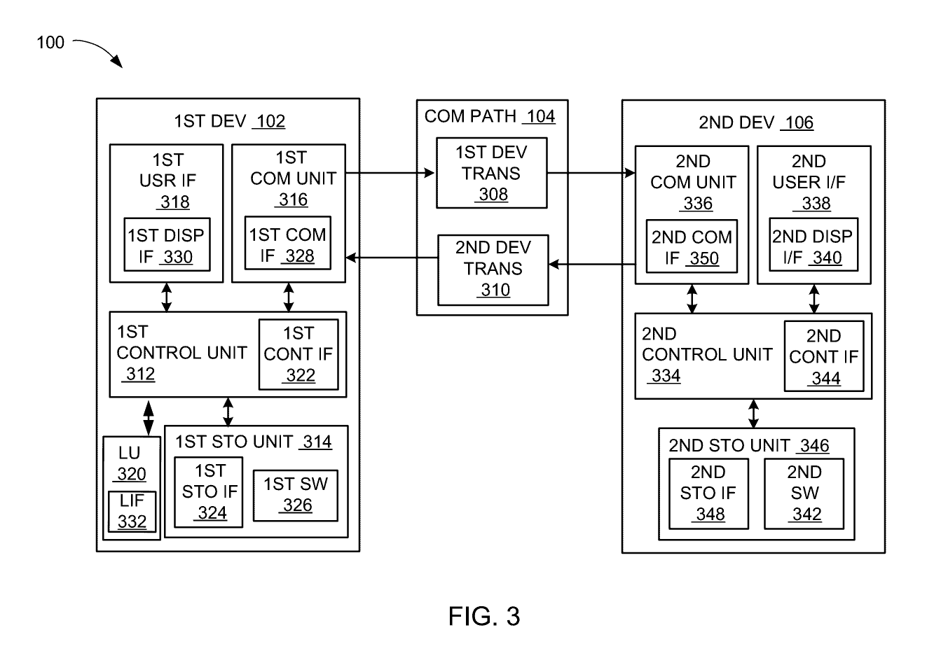

Referring now to FIG. 3, therein is shown an exemplary block diagram of the computing system 100. The computing system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the computing system 100 is shown with the first device 102 as a client device, although it is understood that the computing system 100 can have the first device 102 as a different type of device. For example, the first device 102 can be a server.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 312, a first storage unit 314, a first communication unit 316, a first user interface 318, and a location unit 320. The first control unit 312 can include a first control interface 322. The first control unit 312 can execute a first software 326 to provide the intelligence of the computing system 100. The first control unit 312 can be implemented in a number of different manners. For example, the first control unit 312 can be a processor, an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations physically separate from the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The location unit 320 can generate location information, current heading, and current speed of the first device 102, as examples. The location unit 320 can be implemented in many ways. For example, the location unit 320 can function as at least a part of a global positioning system (GPS), an inertial navigation system, a cellular-tower location system, a pressure location system, or any combination thereof.

The location unit 320 can include a location interface 332. The location interface 332 can be used for communication between the location unit 320 and other functional units in the first device 102. The location interface 332 can also be used for communication that is external to the first device 102.

The location interface 332 can receive information from the other functional units or from external sources, or can transmit information to the other functional units or to external destinations. The external sources and the external destinations refer to sources and destinations physically separate from the first device 102.

The location interface 332 can include different implementations depending on which functional units or external units are being interfaced with the location unit 320. The location interface 332 can be implemented with technologies and techniques similar to the implementation of the first control interface 322.

The first storage unit 314 can store the first software 326. The first storage unit 314 can also store the relevant information, such as advertisements, points of interest (POI), navigation routing entries, or any combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between the location unit 320 and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations physically separate from the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user (not shown) to interface and interact with the first device 102. The first user interface 318 can include an input device and an output device. Examples of the input device of the first user interface 318 can include a keypad, a touchpad, soft-keys, a keyboard, a microphone, a camera, or any combination thereof to provide data and communication inputs.

The first user interface 318 can include a first display interface 330. The first display interface 330 can include a display, a projector, a video screen, a speaker, a headset, or any combination thereof.

The first control unit 312 can operate the first user interface 318 to display information generated by the computing system 100. The first control unit 312 can also execute the first software 326 for the other functions of the computing system 100, including receiving location information from the location unit 320. The first control unit 312 can further execute the first software 326 for interaction with the communication path 104 via the first communication unit 316.

The second device 106 can be optimized for implementing the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, a camera, or any combination thereof to provide data and communication inputs. Examples of the output device of the second user interface 338 can include a second display interface 340. The second display interface 340 can include a display, a projector, a video screen, a speaker, a headset, or any combination thereof.

The second control unit 334 can execute a second software 342 to provide the intelligence of the second device 106 of the computing system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the computing system 100, including operating the second communication unit 336 to communicate with the first device 102 over the communication path 104.

The second control unit 334 can be implemented in a number of different manners. For example, the second control unit 334 can be a processor, an embedded processor, a microprocessor, a hardware control logic, a hardware finite state machine (FSM), a digital signal processor (DSP), or a combination thereof.

The second control unit 334 can include a second control interface 344. The second control interface 344 can be used for communication between the second control unit 334 and other functional units in the second device 106. The second control interface 344 can also be used for communication that is external to the second device 106.

The second control interface 344 can receive information from the other functional units or from external sources, or can transmit information to the other functional units or to external destinations. The external sources and the external destinations refer to sources and destinations physically separate from the second device 106.

The second control interface 344 can be implemented in different ways and can include different implementations depending on which functional units or external units are being interfaced with the second control interface 344. For example, the second control interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the relevant information, such as advertisements, points of interest (POI), navigation routing entries, or any combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the computing system 100 is shown with the second storage unit 346 as a single hierarchy storage system, although it is understood that the computing system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between the location unit 320 and other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations physically separate from the second device 106.

The second storage interface 348 can include different implementations depending on which functional units or external units are being interfaced with the second storage unit 346. The second storage interface 348 can be implemented with technologies and techniques similar to the implementation of the second control interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second control interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The computing system 100 can be executed by the first control unit 312, the second control unit 334, or a combination thereof.

For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100. For example, the first device 102 is described to operate the location unit 320, although it is understood that the second device 106 can also operate the location unit 320.

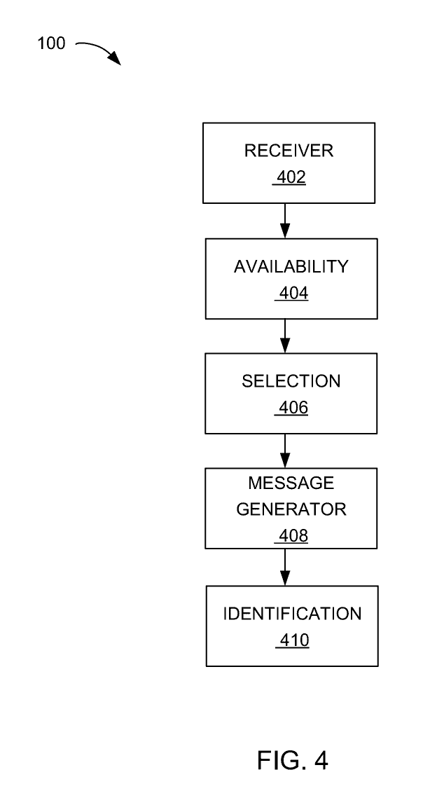

Referring now to FIG. 4, therein is shown a control flow of the computing system 100. The computing system 100 can include a receiver module 402. The receiver module 402 receives the sender application message 208 of FIG. 2. For example, the receiver module 402 can receive the sender application message 208 from the messaging application 206 of FIG. 2 installed on the first device 102 of FIG. 1 used by a user representing the sender 202 of FIG. 2.

More specifically as an example, the user can send the sender application message 208 to another user from the messaging application 206. Another user representing the recipient 204 of FIG. 2 may not have the messaging application 206 installed on the first device 102 operated by the recipient 204. The receiver module 402 can communicate the sender application message 208 to an availability module 404.

The computing system 100 can include the availability module 404, which can be coupled to the receiver module 402. The availability module 404 determines the channel availability 228 of FIG. 2. For example, the availability module 404 can determine the channel availability 228 based on the mapping table 232 of FIG. 2, the sender application message 208, or a combination thereof.

The availability module 404 can determine the channel availability 228 in a number of ways. For example, the mapping table 232 can include the recipient information 224 of FIG. 2, the sender information 220 of FIG. 2, the timestamp 234 of FIG. 2, the channel 226 of FIG. 2, the communication status 230 of FIG. 2, or a combination thereof. The sender application message 208 can include the sender information 220, the recipient information 224, or a combination thereof.

More specifically as an example, the availability module 404 can determine the channel availability 228 based on looping through the mapping table 232 to determine if there is the channel 226 including the communication status 230 as “idle” for the recipient 204. If the channel 226 is idle, the availability module 404 can determine the channel availability 228 as “available” for the recipient 204. If the communication status 230 is “not idle,” the availability module 404 can determine the channel availability 228 as “unavailable.” The availability module 404 can communicate the channel availability 228 to a selection module 406.

The computing system 100 can include the selection module 406, which can be coupled to the availability module 404. The selection module 406 selects the channel 226. For example, the selection module 406 can select the channel 226 based on the channel availability 228 for establishing communication between the sender 202 and the recipient 204.

The selection module 406 can select the channel 226 in a number of ways. For example, the channel availability 228 can represent “available.” If the channel 226 is available, the selection module 406 can select the channel 226 to communicate with the recipient 204. More specifically as an example, as discussed above, the mapping table 232 can map or establish relationship between the sender 202 and the recipient 204. By selecting the channel 226, the sender 202 can communicate to the recipient 204.

For a different example, the channel availability 228 can represent “unavailable.” If the channel 226 is unavailable, the selection module 406 can select the channel 226 having the timestamp 234 of least recently used from the mapping table 232. For further example, the selection module 406 can update the timestamp 234 in the mapping table 232 to indicate that the corresponding instance of the channel 226 has been used after selecting the channel 226. The selection module 406 can communicate the channel 226 to a message generator module 408.

The computing system 100 can include the message generator module 408, which can be coupled to the selection module 406. The message generator module 408 generates the application message 236 of FIG. 2, the non-application message 238 of FIG. 2, or a combination thereof. For example, the message generator module 408 can generate the application message 236 including the sender application message 208, the reply application message 214 of FIG. 2, or a combination thereof. For a different example, the message generator module 408 can generate the non-application message 238 including the sender text message 210 of FIG. 2, the reply text message 212 of FIG. 2, or a combination thereof.

For specific example, the message generator module 408 can generate the sender text message 210 for communicating to the recipient 204 operating the first device 102 without the messaging application 206. For further example, the message generator module 408 can generate the sender text message 210, the sender application message 208, the reply text message 212, the reply application message 214, or a combination thereof based on the communication preference 218.

For a specific example, the message generator module 408 can generate the sender text message 210 based on converting the sender application message 208 into the sender text message 210 dynamically and in real time. Real time can represent an actual time during a process or event occurs. Dynamically can represent a constant change, activity, or progress due to change in circumstance or event.

As discussed above, the first device 102 of the recipient 204 can include the Short Message Service client but without the messaging application 206 to receive the sender application message 208. The message generator module 408 can generate the sender text message 210 by including the sender information 220, the recipient information 224, the message content 216 of FIG. 2 from the sender application message 208 for communicating the sender text message 210 to the first device 102 operating the Short Message Service client instead of the messaging application 206. More specifically as an example, the message generator module 408 can send the sender text message 210 via the channel 226 selected for communicating the sender application message 208 to the recipient 204 as discussed above.

It has been discovered that the computing system 100 converting the sender application message 208 into the sender text message 210 dynamically and in real time significantly improves the efficiency of communication between multiple devices using different communication format. By converting the sender application message 208 into the sender text message 210, the first device 102 without the messaging application 206 can now communicate with the first device 102 with the messaging application 206 seamlessly. The conversion of the sender application message 208 into the sender text message 210 solves the problem of inefficient communication between different communication format/protocol. As a result, the computing system 100 can significantly improve the operation of the computing system 100, the first device 102, or a combination thereof by eliminating compatibility issues between different communication formats/protocols.

For illustrative purposes, the computing system 100 is described with the receiver module 402 receiving the sender application message 208, although it is understood that the receiver module 402 can operate differently. For example, the receiver module 402 can receive the reply text message 212. For a specific example, the receiver module 402 can receive the reply text message 212 as a response to the sender text message 210 from the first device 102. More specifically as an example, the first device 102 can send the reply text message 212 via the Short Message Service client.

For further example, the receiver module 402 can receive the reply text message 212 for calling back to the communication identification 222 of FIG. 2 representing a Uniform Resource Locator configured to the channel 226. More specifically as an example, the receiver module 402 can callback the reply text message 212 via the channel 226 configured for responding to the sender application message 208 originally sent to the recipient 204. The receiver module 402 can communicate the reply text message 212, the communication identification 222, or a combination thereof to an identification module 410.

The computing system 100 can include the identification module 410, which can be coupled to the receiver module 402. The identification module 410 determines the sender information 220. For example, the identification module 410 can determine the sender information 220 based on the mapping table 232, the reply text message 212, or a combination thereof.

More specifically as an example, the identification module 410 can determine the sender information 220 for the sender 202 that had sent the sender application message 208 originally that the recipient 204 is replying with the reply text message 212. The identification module 410 can determine the sender information 220 by identifying the sender information 220, the recipient information 224, the channel 226, or a combination thereof assigned for the communication of the sender application message 208 originally sent. By locating the channel 226 assigned for the sender application message 208, the identification module 410 can identify the sender information 220. The identification module 410 can communicate the sender information 220 to the message generator module 408.

For illustrative purposes, the computing system 100 is described with the message generator module 408 generating the sender text message 210, although it is understood that the message generator module 408 can operate differently. For example, the message generator module 408 can generate the reply application message 214 for communicating the reply text message 212 to the first device 102 with the messaging application 206.

As discussed above, the first device 102 of the sender 202 sent the sender application message 208 to the recipient 204 with the first device 102 without the messaging application 206. In response, the recipient 204 replied with the reply text message 212. The message generator module 408 can generate the reply application message 214 by converting the reply text message 212 into the reply application message 214 in order for the messaging application 206 on the first device 102 of the sender 202 to receive the reply text message 212.

More specifically as an example, the message generator module 408 can generate the reply application message 214 based on the communication preference 218 to include the message content 216, the sender information 220, the recipient information 224, or a combination thereof. For a different example, the message generator module 408 can push the sender information 220, the recipient information 224, the message content 216, or a combination thereof for the messaging application 206 residing on the first device 102 of the sender 202 to generate the reply messaging application 206 for the sender 202 to see the reply from the recipient 204.

For a specific example, the mapping table 232 can indicate the communication preference 218 of when the user is the sender 202, the recipient 204, or a combination thereof. More specifically as an example, the communication preference 218 when the user is the sender 202 versus when the user is the recipient 204 can be different. For example, when the user is the sender 202, the communication preference 218 can indicate that the sender application message 208 to be sent as LINE™. In contrast, when the user is the recipient 204, the communication preference 218 can indicate that the reply application message 214 to be sent as WhatsApp™. For further example, when the user is the sender 202, the communication preference 218 can indicate to use instant messaging if the messaging application 206 is installed on the first device 102 of the sender 202. For another example, when the first device 102 of the recipient 204 does not have the messaging application 206 installed, the communication preference 218 of the sender 202 can indicate to use the text messaging service component.

It has been discovered that the computing system 100 converting the reply text message 212 into the reply application message 214 dynamically and in real time significantly improves the efficiency of communication between multiple devices using different communication format. By converting the reply text message 212 into the reply application message 214, the first device 102 without the messaging application 206 can now communicate with the first device 102 with the messaging application 206 seamlessly. The conversion of the reply text message 212 into the reply application message 214 solves the problem of inefficient communication between different communication format/protocol. As a result, the computing system 100 can significantly improve the operation of the computing system 100, the first device 102, or a combination thereof by eliminating compatibility issues between different communication formats/protocols.

The physical transformation from sending the sender application message 208 to the recipient 204 results in the movement in the physical world, such as people using the first device 102, the vehicle, or a combination thereof, based on the operation of the computing system 100. As the movement in the physical world occurs, the movement itself creates additional information that is converted back into generating the sender text message 210, the reply text message 212, the reply application message 214, or a combination thereof for the continued operation of the computing system 100 and to continue the movement in the physical world.

The first software 326 of FIG. 3 of the first device 102 of FIG. 3 can include the modules for the computing system 100. For example, the first software 326 can include the receiver module 402, the availability module 404, the selection module 406, the message generator module 408, and the identification module 410.

The first control unit 312 of FIG. 3 can execute the first software 326 for the receiver module 402 to receive the sender application message 208, the reply text message 212, or a combination thereof. The first control unit 312 can execute the first software 326 for the availability module 404 to determine the channel availability 228.

The first control unit 312 can execute the first software 326 for the selection module 406 to select the channel 226. The first control unit 312 can execute the first software 326 for the message generator module 408 to generate the sender text message 210, the reply application message 214, or a combination thereof. The first control unit 312 can execute the first software 326 for the identification module 410 to determine the sender information 220.

The second software 342 of FIG. 3 of the second device 106 of FIG. 3 can include the modules for the computing system 100. For example, the second software 342 can include the receiver module 402, the availability module 404, the selection module 406, the message generator module 408, and the identification module 410.

The second control unit 334 of FIG. 3 can execute the second software 342 for the receiver module 402 to receive the sender application message 208, the reply text message 212, or a combination thereof. The second control unit 334 can execute the second software 342 for the availability module 404 to determine the channel availability 228.

The second control unit 334 can execute the second software 342 for the selection module 406 to select the channel 226. The second control unit 334 can execute the second software 342 for the message generator module 408 to generate the sender text message 210, the reply application message 214, or a combination thereof. The second control unit 334 can execute the second software 342 for the identification module 410 to determine the sender information 220.

The modules of the computing system 100 can be partitioned between the first software 326 and the second software 342. The second software 342 can include the receiver module 402, the availability module 404, the selection module 406, and the identification module 410. The second control unit 334 can execute modules partitioned on the second software 342 as previously described.

The first software 326 can include the message generator module 408. Based on the size of the first storage unit 314, the first software 326 can include additional modules of the computing system 100. The first control unit 312 can execute the modules partitioned on the first software 326 as previously described.

The first control unit 312 can operate the first communication unit 316 of FIG. 3 to communicate the sender application message 208, the sender text message 210, the reply text message 212, the reply application message 214, the channel 226, the sender information 220, the recipient information 224, or a combination thereof to or from the second device 106 through the communication path 104 of FIG. 3. The first control unit 312 can operate the first software 326 to operate the location unit 320 of FIG. 3. The second control unit 334 can operate the second communication unit 336 of FIG. 3 to communicate the sender application message 208, the sender text message 210, the reply text message 212, the reply application message 214, the channel 226, the sender information 220, the recipient information 224, or a combination thereof to or from the first device 102 through the communication path 104.

The computing system 100 describes the module functions or order as an example. The modules can be partitioned differently. For example, the availability module 404 and the selection module 406 can be combined. Each of the modules can operate individually and independently of the other modules. Furthermore, data generated in one module can be used by another module without being directly coupled to each other. For example, the identification module 410 can receive the channel 226 from the selection module 406. Further, one module communicating to another module can represent one module transmitting, sending, receiving, or a combination thereof the data generated to or from another module.

The modules described in this application can be hardware implementation or hardware accelerators in the first control unit 312 or in the second control unit 334. The modules can also be hardware implementation or hardware accelerators within the first device 102 or the second device 106 but outside of the first control unit 312 or the second control unit 334, respectively as depicted in FIG. 3. However, it is understood that the first control unit 312, the second control unit 334, or a combination thereof can collectively refer to all hardware accelerators for the modules. Furthermore, the first control unit 312, the second control unit 334, or a combination thereof can be implemented as software, hardware, or a combination thereof.

The modules described in this application can be implemented as instructions stored on a non-transitory computer readable medium to be executed by the first control unit 312, the second control unit 334, or a combination thereof. The non-transitory computer medium can include the first storage unit 314, the second storage unit 346 of FIG. 3, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

For example, the non-transitory computer readable medium including instructions for execution, the instructions can comprise: receiving the application message for communicating with the first device of the sender with the messaging application installed; and generating the non-application message based on converting the application message dynamically and in real time for communicating with the first device of the recipient without the messaging application installed. For a different example, the non-transitory computer readable medium including instructions for execution, the instructions can comprise: receiving the non-application message for communicating with the first device of the sender without the messaging application installed; and generating the application message based on converting the non-application message dynamically and in real time with a control unit for communicating with the device of the recipient with the messaging application installed.

It has been discovered that the computing system 100 generating the sender text message 210 based on the communication preference 218, the sender application message 208, or a combination thereof improves the efficiency of communicating between the sender 202 and the recipient 204. By generating the sender text message 210, the sender 202 can send a Short Message Service text message from the messaging application 206 even though the first device 102 of the recipient 204 does not have the messaging application 206 installed. Moreover, by generating the sender text message 210, the computing system 100 allows a seamless communication between the messaging application 206 and the Short Message Service client. As a result, the computing system 100 improves the efficiency of communication between the sender 202 and the recipient 204 by reducing resource required for communication.

It has further been discovered that the computing system 100 generating the reply application message 214 based on the communication preference 218, the reply text message 212, or a combination thereof improves the efficiency of the recipient 204 replying to the sender 202. By generating the reply application message 214, the recipient 204 can send a message compatible for the messaging application 206 from the Short Message Service client without installing the messaging application 206 on the first device 102 of the recipient 204. As a result, the computing system 100 improves the efficiency of communication between the sender 202 and the recipient 204 by reducing resource required for communication.

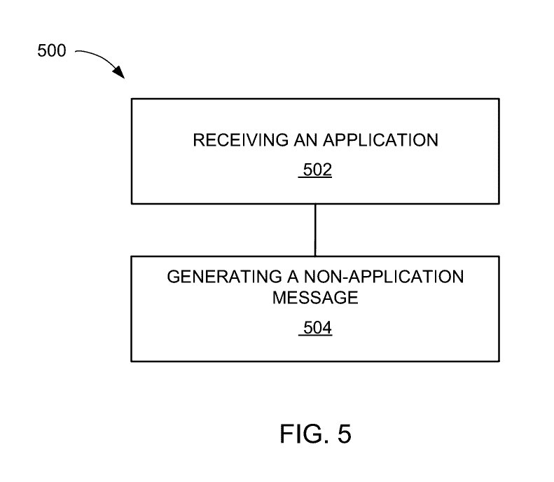

Referring now to FIG. 5, therein is shown a flow chart of a method 500 of operation of the computing system 100 in a further embodiment of the present invention. The method 500 includes: receiving an application message for communicating with a device of a sender with a messaging application installed in a block 502; and generating a non-application message based on converting the application message dynamically and in real time with a control unit for communicating with the device of a recipient without the messaging application installed in a block 504.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a computing system comprising:
receiving an application message for communicating with a device of a sender with a messaging application installed; and
generating a non-application message based on converting the application message dynamically and in real time with a control unit for communicating with the device of a recipient without the messaging application installed.

2. The method as claimed in claim 1 further comprising determining a channel availability based on a channel status of a channel for communicating the non-application message.

3. The method as claimed in claim 1 further comprising communicating the non-application message via a channel selected for communicating a message content of the application message to the recipient.

4. The method as claimed in claim 1 further comprising determining a recipient information of the application message based on a channel assigned for receiving the non-application message by the recipient.

5. The method as claimed in claim 1 further comprising updating a mapping table for indicating a channel has been used after selecting the channel.

6. A method of operation of a computing system comprising:
receiving a non-application message for communicating with a device of a sender without a messaging application installed; and
generating an application message based on converting the non-application message dynamically and in real time with a control unit for communicating with the device of a recipient with the messaging application installed.

7. The method as claimed in claim 6 further comprising determining a channel availability based on a channel status of a channel for communicating the application message.

8. The method as claimed in claim 6 further comprising communicating the application message via a channel selected for communicating a message content of the non-application message to the recipient.

9. The method as claimed in claim 6 further comprising determining a recipient information of the non-application message based on a channel assigned for receiving the application message by the recipient.

10. The method as claimed in claim 6 further comprising updating a mapping table for indicating a channel has been used after selecting the channel.

11. A computing system comprising:
a communication unit for receiving an application message for communicating with a device of a sender with a messaging application installed; and
a control unit, coupled to the communication unit, for generating a non-application message based on converting the application message dynamically and in real time with a control unit for communicating with the device of a recipient without the messaging application installed.

12. The system as claimed in claim 11 wherein the control unit is for determining a channel availability based on a channel status of a channel for communicating the non-application message.

13. The system as claimed in claim 11 wherein the control unit is for communicating the non-application message via a channel selected for communicating a message content of the application message to the recipient.

14. The system as claimed in claim 11 wherein the control unit is for determining a recipient information of the application message based on a channel assigned for receiving the non-application message by the recipient.

15. The system as claimed in claim 11 wherein the control unit is for updating a mapping table for indicating a channel has been used after selecting the channel.

16. A computing system comprising:
a communication unit for receiving a non-application message for communicating with a device of a sender without a messaging application installed; and
a control unit, coupled to the communication unit, for generating an application message based on converting the non-application message dynamically and in real time with a control unit for communicating with the device of a recipient with the messaging application installed.

17. The system as claimed in claim 16 wherein the control unit is for determining a channel availability based on a channel status of a channel for communicating the application message.

18. The system as claimed in claim 16 wherein the control unit is for communicating the application message via a channel selected for communicating a message content of the non-application message to the recipient.

19. The system as claimed in claim 16 wherein the control unit is for determining a recipient information of the non-application message based on a channel assigned for receiving the application message by the recipient.

20. The system as claimed in claim 16 wherein the control unit is for updating a mapping table for indicating a channel has been used after selecting the channel.
